(19) United States
(12) Patent Application Publication
(10) Pub. No.: US 2024/0143529 A1
(43) Pub. Date: May 2, 2024

(54) SYSTEM AND METHOD FOR ACCESSING REMOTE TARGET DEVICE AND REMOTE EXTENDER THEREOF

(71) Applicant: INNODISK CORPORATION, New Taipei City (TW)

(72) Inventors: YU-HAN LIU, New Taipei City (TW); SHENG-CHE CHUEH, New Taipei City (TW); CHONG-LI HUANG, New Taipei City (TW)

(21) Appl. No.: 18/119,296

(22) Filed: Mar. 9, 2023

Related U.S. Application Data
(60) Provisional application No. 63/420,688, filed on Oct. 31, 2022.

(51) Int. Cl. G06F 13/28; G06F 21/60

(52) U.S. Cl. CPC G06F 13/28; G06F 21/606

(57) ABSTRACT

A method for a host computer to access a target device via a remote extender. The target device is connected to the remote extender, and a target device driver corresponding to the target device is installed on the host computer. The method includes setting up a logic transmission pipe between the host computer and the remote extender with a network connection as the underlying transmission path, and handling an I/O request from the target device driver to access the target device via the logic transmission pipe. The method is used to allow the target device to be treated by the host computer as a local resource. Additionally, the disclosure provides a system for accessing the remote target device and a remote extender thereof.

### CROSS-REFERENCE TO RELATED APPLICATION

This non-provisional application claims priority under 35 U.S.C. § 119(e) on U.S. provisional Patent Application Nos. 63/420,688 filed on Oct. 31, 2022, the entire contents of which are hereby incorporated by reference.

### BACKGROUND OF THE INVENTION

### 1. Field of the Invention

The present disclosure relates to accessing a target device, and in particular to a remote extender system and a method that accesses a remote target device via the remote extender.

### 2. Description of the Related Art

Conventionally, in order to access a remote target device, a host computer must be configured to communicate via a wired or wireless connection to a remote computer that has a driver installed for the remote target device. The remote target device is connected to an input/output (I/O) port of the remote computer, and allows access from the host computer via the remote computer. In the above configuration, the target device is not treated as a local resource available to the host computer, but as a local resource of the remote computer. Thus, in order to access multiple remote target devices in a facility (for example, a factory or a large warehouse), it is necessary for the facility to deploy multiple remote computers to access the multiple remote target devices at different locations, and this leads to increased network complexities and costs of the overall system.

### BRIEF SUMMARY OF THE INVENTION

In view of the disadvantages of the prior art, the present invention discloses a method for a host computer to access a remote target device via a remote extender. The remote target device is connected to the remote extender. A target device driver corresponding to the remote target device is installed on the host computer. The method includes setting up a logic transmission pipe with a network connection between the host computer and the remote extender as an underlying transmission path, and handling an I/O request from the target device driver to access the target device via the logic transmission pipe.

In an embodiment, the present invention discloses a remote extender for a host computer to access a target device connected to the remote extender. The host computer includes a target device driver, a virtual bus driver, and a first network service manager. The remote extender includes a second network service manager and a virtual control unit. The second network service manager is operable to set up a network connection to the first network service manager of the host computer. The virtual control unit is operable to set up a logic transmission pipe to the virtual bus driver of the host computer, and handle an I/O request from the target device driver of the host computer to access the target device via the logic transmission pipe.

In yet another embodiment, the present invention discloses a system for accessing a remote target device, the system comprises a host computer and a remote extender. The host computer includes a target device driver, a virtual bus driver, and a first network service manager. The remote extender includes a virtual control unit and a second network service manager. The remote extender is operable to connect to a target device corresponding to the target device driver. The first network service manager and the second network service manager are operable to establish a network connection. The virtual bus driver and the virtual control unit are operable to set up a logic transmission pipe with the network connection as an underlying transmission path, and handle an I/O request from the target device driver of the host computer to access the target device via the logic transmission pipe.

With the above technical means, the remote target device is treated as a local resource by the host computer, hence reducing network complexities and costs of the overall system.

### BRIEF DESCRIPTION OF THE DRAWINGS

FIG. 1 is a block diagram of a system for accessing a remote target device according to an embodiment of the present disclosure.

FIG. 2 is a flowchart of an initialization operation of the system in FIG. 1 according to an embodiment of the present disclosure.

FIG. 3 is a flowchart of an operation of the system in FIG. 1 according to an embodiment of the present disclosure.

### DETAILED DESCRIPTION OF THE INVENTION

To facilitate understanding of the object, characteristics, and effects of the present disclosure, embodiments together with the attached drawings for the detailed description of the present disclosure are provided.

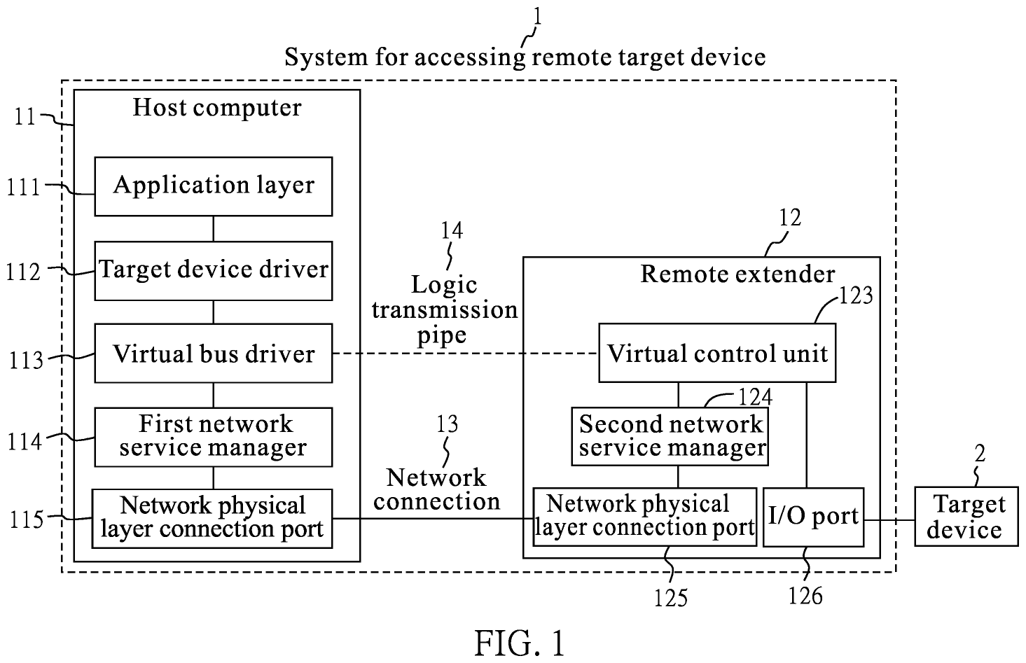

Refer to FIG. 1, which illustrates a system 1 for accessing a target device 2 according to an embodiment of the present disclosure. The system 1 includes a host computer 11 and a remote extender 12. The host computer 11 may be a desktop computer, a laptop computer, a smart phone, or a server, and includes a central processing unit (CPU), a primary storage device, a secondary storage device, and an input/output (I/O) unit. The primary storage device may be a dynamic random access memory (DRAM). The secondary storage device may be a solid state drive (SSD) or a hard disc drive (HDD). The I/O unit may be a display, a keyboard, and/or a mouse. The remote extender 12 may be an application-specific device, and includes a main processor and a storage device storing software modules with various necessary functions.

In an embodiment, the host computer 11 includes an application layer 111, a target device driver 112, a virtual bus driver 113, a first network service manager 114, and a network physical layer connection port 115. The application layer 111 is operable for a user to execute various applications, for example, a factory management application.

The target device driver 112 is a driver for the target device 2, and is installed in the host computer 11. It should be noted that, the target device driver 112 is not installed in the remote extender 12.

The virtual bus driver 113 is operable to obtain device information of the target device 2, for example, a vendor identifier/product identifier of the target device 2 and an operating state. The virtual bus driver 113 interacts with the target device driver 112, as if the remote target device 2 is virtually locally connected to the host computer 11. The virtual bus driver 113 maintains a logic transmission pipe 14 to the remote extender 12, and transmits a request from the target device driver 112 to the target device 2 via the logic transmission pipe 14 with a network connection 13 as an underlying transmission path.

The first network service manager 114 is operable to manage the underlying network connection 13 to the remote extender 12, for example, an Ethernet connection. The network physical layer connection port 115 is a physical connection port, for example, an RJ-45 socket, and is operable to receive a network connector, for example, an RJ-45 connector. The first network service manager 114 is operable to compress data of the virtual bus driver 113 into a format in compliance with a network protocol so that the data can be transmitted via the network connection 13. The network protocol may be a packet format of the Transmission Control Protocol/Internet Protocol (TCP/IP) or User Datagram Protocol (UDP).

The remote extender 12 includes a virtual control unit 123, a second network service manager 124, a network physical layer connection port 125, and an I/O port 126. The virtual control unit 123 may be a computer software module. The virtual control unit 123 is operable to maintain the logic transmission pipe 14 to the virtual bus driver 113 of the host computer 11. The virtual control unit 123 is also operable to manage connection to the target device 2 connected to the I/O port 126.

In an example, the virtual control unit 123 can handle data and/or a request from the logic transmission pipe 14 through the sysfs file system and the input/output control (ioct1) system function of the Linux operating system, and send physical layer raw binary data via a customized Direct Memory Access (DMA) technique to the target device 2. The sysfs file system is a virtual file system that can be used to provide an interface to a kernel data structure from kernel 2.6 onwards. The ioct1 system function can be used to operate underlying device parameters of a predetermined file (for example, a terminal). Operation properties of the predetermined file can be controlled by a request of the ioct1 system function. With the sysfs file system and the ioct1 system function, a devices can be accessed without compiling a kernel driver. For example, “device-node” including numbers or including numbers and strings into a file named “export” or “bind” to obtain device control on the Linux operating system. The buffer size of the DMA technique can be adjusted according to the performance of the CPU, network speed, and/or device performance.

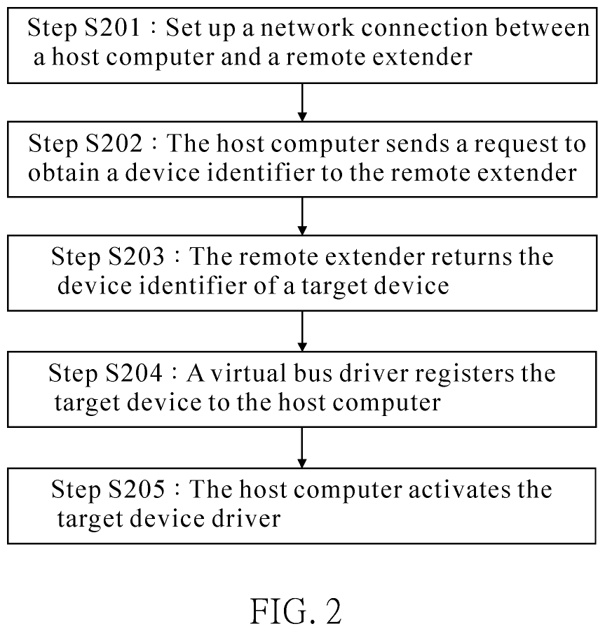

Refer to FIG. 2, which illustrates an initialization process of the system 1 of FIG. 1, step S201 is first performed to set up the network connection 13 between the host computer 11 and the remote extender 12. For example, the first network service manager 114 of the host computer 11 may send a request to the second network service manager 124 of the remote extender 12, so as to set up a safe Internet Protocol Security (IPSec) channel as the network connection 13. The second network service manager 124 may decline a request according to a pre-configured whitelist. Step S201 may be automatically performed during the initialization procedure of the system 1, or may be manually performed by a user of the host computer 11.

Next, in step S202, the host computer 11 sends a request to the remote extender 12 to obtain a device identifier of the target device 2. For example, the operating system of the host computer 11 requests for device identifiers of all connected peripheral devices. The virtual bus driver 113 transmits the request to the first network service manager 114, so as to send the request to the virtual control unit 123 of the remote extender 12 via the network connection 13 set up in step S201.

In step S203, the remote extender 12 returns the device identifier of the target device 2. For example, the virtual control unit 123 of the remote extender 12 uses the sysfs file system and the ioct1 system function of the Linux operating system to manage the target device 2 connected to the I/O port 126. After receiving the request issued from the host computer 11, the virtual control unit 123 sends the device identifier of the target device 2 registered in a user space of the sysfs file system in response to the request.

In step S204, the virtual bus driver 113 registers the target device 2 with the host computer 11. For example, the virtual bus driver 113 may register the target device with the operating system of the host computer 11 according to the device identifier returned by the virtual control unit 123 of the remote extender 12.

In step S205, the host computer 11 activates the target device driver 112. This a step performed after the virtual bus driver 113 registers the target device 2 with the operating system of the host computer 11. It should be noted that, by registering the target device 2 with the operating system of the host computer 11, the target device 2 can substantially become a local resource of the host computer 11. That is to say, the virtual bus driver 113 sets up the virtual target device 2 at the host computer 11, allowing an application of the application layer 111 of the host computer 11 to directly access and treat the target device 2 as a local resource.

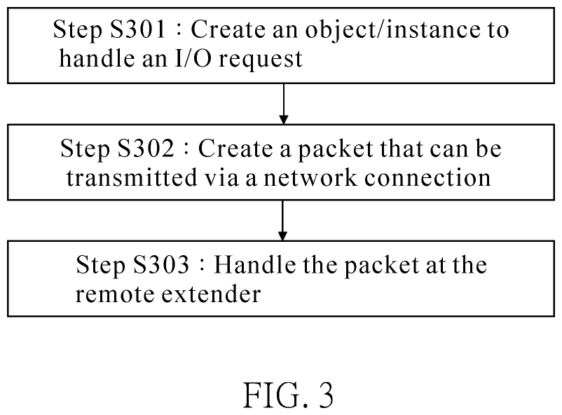

Once the network connection 13 is set up and the target device 2 is registered with the host computer 11, the logic transmission pipe 14 is ready to use the network connection 13 as an underlying transmission path. Refer to FIG. 3 for further details. When the target device driver 112 sends an I/O request, the I/O request is handled by the virtual bus driver 113. The virtual bus driver 113 performs step S301 to create an object or an instance to handle a process of the I/O request. Then, the first network service manager 114 performs step S302 to create a packet including a device identifier, a request type, and physical layer data. The request type may be synchronous or asynchronous. The physical layer data is raw binary data transmitted via the network connection 13. The device identifier may be a data structure including a Universally Unique Identifier (UUID), a path of the target device 2, and pairing information. The pairing information may include an Internet Protocol (IP) address of the remote extender 12 and the device identifier of the target device 2 at the remote extender 12. Then, the packet is transmitted via the network connection 13 (for example, an Internet Protocol Security (IPSec) channel).

After receiving the packet for handling the I/O request, the virtual control unit 123 performs step S303 to handle the packet through the sysfs file system and ioct1 system function of the Linux operating system, thereby sending the physical layer raw binary data to the target device 2 via the customized DMA technique. The virtual control unit 123 may adjust the DMA according to the performance of the remote extender 12 (for example, a data rate of the network physical layer connection port 125).

With the configuration of the embodiment, the remote extender 12 is capable of significantly enhancing the I/O ability of the host computer 11. The target device 2 connected to the remote extender 12 may be treated as a “virtual” local resource by the host computer 11. This allows a user to access the target device 2 with the host computer 11, as if the target device 2 is directly connected to the host computer 11. Accordingly, operation complexities can be reduced for the user.

In addition, the remote extender 12 does not need to be installed with a target device driver, nor does the remote extender 12 need to include an application layer that executes various applications. Thus, the remote extender 12 may be an application-specific device for extending the I/O ability of the host computer 11, but not considered as a general-purpose computer. Accordingly, the complexities and costs of the overall system 1 are reduced.

Moreover, the remote extender 12 can provide a plurality of I/O ports 126 that support different industry standards, for example, Controller Area Network (CAN), asynchronous data transmission standard interface (RS-232), Video Graphics Array (VGA), High Definition Multimedia Interface (HDMI), and/or Universal Serial Bus (USB). Provided that different target device drivers 112 are installed at the host computer 11, different target devices 2 in compliance with different industry standards can be connected to different I/O ports 126 of the remote extender 12.

In addition, the host computer 11 may be connected to a plurality of remote extenders 12 via the same network. For example, provided that the host computer 11 and the plurality of remote extenders 12 are connected to the same Local Area Network (LAN), the host computer 11 can set up a plurality of network connections 13 to the remote extenders 12, respectively. This significantly improves the I/O ability of the host computer 11 and flexibilities of the overall system 1.

While the present invention has been described by means of specific embodiments, numerous modifications and variations could be made thereto by those skilled in the art without departing from the scope and spirit of the present invention set forth in the claims. Therefore, the scope of legal protection of the present invention should be defined by the appended claims.

What is claimed is:

1. A method for accessing a remote target device, for a host computer to access a target device via a remote extender, the target device connected to the remote extender, a target device driver corresponding to the target device being installed on the host computer; the method comprising:
setting up a logic transmission pipe with a network connection between the host computer and the remote extender as an underlying transmission path; and
handling an I/O request from the target device driver to access the target device via the logic transmission pipe.

2. The method for accessing a remote target device according to claim 1, wherein the setting up of the logic transmission pipe between the host computer and the remote extender comprises:
sending a request by the host computer to the remote extender to obtain a device identifier of the target device;
receiving the device identifier of the target device returned from the remote extender;
registering the device identifier with the host computer; and
activating the target device driver from the host computer.

3. The method for accessing a remote target device according to claim 2, wherein the handling of the I/O request via the logic transmission pipe comprises:
creating a packet comprising the device identifier; and
transmitting the packet via the network connection.

4. The method for accessing a remote target device according to claim 1, further comprising:
setting up the network connection between the host computer and the remote extender.

5. The method for accessing a remote target device according to claim 1, wherein the network connection is an Internet Protocol Security (IPSec) channel.

6. The method for accessing a remote target device according to claim 1, further comprising:
handling the I/O request by a customized Direct Memory Access (DMA) technique at the remote extender.

7. A remote extender, for a host computer to access a target device connected to the remote extender, the host computer comprising a target device driver, a virtual bus driver and a first network service manager; the remote extender comprising:
a second network service manager, operable to set up a network connection to the first network service manager of the host computer; and
a virtual control unit, operable to set up a logic transmission pipe to the virtual bus driver of the host computer, and handle an I/O request from the target device driver of the host computer to access the target device via the logic transmission pipe.

8. The remote extender according to claim 7, wherein the virtual control unit setting up the logic transmission pipe to the virtual bus driver comprises:
receiving a request from the host computer to obtain a device identifier of the target device; and
returning the device identifier of the target device to the host computer.

9. The remote extender according to claim 8, wherein the virtual control unit handling the I/O request via the logic transmission pipe comprises:
receiving a packet comprising the device identifier via the network connection.

10. The remote extender according to claim 7, wherein the virtual control unit handling the I/O request via the logic transmission pipe comprises:
handling the I/O request by a customized Direct Memory Access (DMA) technique.

11. The remote extender according to claim 7, wherein the network connection is an Internet Protocol Security (IPSec) channel.

12. The remote extender according to claim 7, further comprising:
an I/O port, operable to connect to the target device.

13. The remote extender according to claim 12, wherein the I/O port is plural in quantity, and at least two of the I/O ports are in compliance with different industry standards.

14. A system for accessing a remote target device, comprising:
a host computer, comprising a target device driver, a virtual bus driver and a first network service manager; and
a remote extender, comprising a virtual control unit and a second network service manager;
wherein the remote extender is operable to connect to a target device corresponding to the target device driver, wherein the first network service manager and the second network service manager are operable to set up a network connection, and wherein the virtual bus driver and the virtual control unit are operable to set up a logic transmission pipe with the network connection as an underlying transmission path, and handle an I/O request from the target device driver of the host computer to access the target device via the logic transmission pipe.

15. The system for accessing a remote target device according to claim 14, wherein the virtual bus driver and the virtual control unit setting up the logic transmission pipe comprises:
receiving a request from the host computer to obtain a device identifier of the target device; and
returning the device identifier of the target device to the host computer.

16. The system for accessing a remote target device according to claim 15, wherein the handling of the I/O request via the logic transmission pipe comprises:
receiving a packet comprising the device identifier via the network connection.

17. The system for accessing a remote target device according to claim 14, wherein the handling of the I/O request via the logic transmission pipe comprises:
handling the I/O request by a customized Direct Memory Access (DMA) technique at the remote extender.

18. The system for accessing a remote target device according to claim 14, wherein the network connection is an Internet Protocol Security (IPSec) channel.

19. The system for accessing a remote target device according to claim 14, wherein the remote extender comprises:
an I/O port, operable to connect to the target device.

20. The system for accessing a remote target device according to claim 19, wherein the I/O port is plural in quantity, and at least two of the I/O ports are in compliance with different industry standards.
